(19) United States
(12) Patent Application Publication
(10) Pub. No.: US 2025/0038916 A1
(43) Pub. Date: Jan. 30, 2025

(54) USER DEVICE ORIENTATION

(71) Applicant: NOKIA TECHNOLOGIES OY, Espoo (FI)

(72) Inventors: Oana-Elena Barbu, Aalborg (DK); Diomidis Michalopoulos, Munich (DE); Ryan Keating, Chicago, IL (US); Benny Vejlgaarde, Gistrup (DK)

(21) Appl. No.: 18/705,489

(22) PCT Filed: Oct. 27, 2021
(86) PCT No.: PCT/EP2021/079809

§ 371 Date: Apr. 26, 2024

(51) Int. Cl. H04L 5/00; G01S 5/02; H04W 64/00

(52) U.S. Cl. CPC H04L 5/0051; G01S 5/0247; G01S 5/0273; H04W 64/00

(57) ABSTRACT

An apparatus, method and computer program is described comprising: sampling a positioning reference signal received at a user device of a mobile communication system from a communication node of the mobile communication system, wherein the received positioning reference signal is a multipath signal having a line of sight component; processing the sampled received positioning reference signal with the positioning reference signal as transmitted by the communication node; identifying, based on said processing, signal paths from the communication node to the user device relative to an angle of departure of the positioning reference signal; and generating a model to estimate at least one of an orientation of the user device and a gain of the one or more identified signal paths of the multipath signal.

### FIELD

Embodiments as set out in this patent application relate to estimation of user device orientation, for example as part of user device positioning and orientation in a mobile communication system.

### BACKGROUND

Positioning reference signals can be used to estimate a position of a user device of a mobile communication system. There remains a need for further developments in this field.

### SUMMARY

In a first aspect, the specification describes an apparatus comprising means for performing: sampling a positioning reference signal received at a user device (e.g. measured by the user device) of a mobile communication system from a communication node of the mobile communication system, wherein the received positioning reference signal is a multipath signal having a line of sight component; processing (e.g. post-processing) the sampled received positioning reference signal with the positioning reference signal as transmitted by the communication node; identifying, based on said processing, signal paths from the communication node to the user device relative to an angle of departure of the positioning reference signal; and generating a model (e.g. mapping the received positioning reference signal to the angle delay domain) to estimate an orientation of the user device and a gain of at least one of the one or more identified signal paths of the multipath signal. The apparatus may further comprise means for performing: generating a vector based on the identified signal paths.

The processing (e.g. post-processing) may take the form of cross-correlation of the sampled received positioning reference signals with the positioning reference signal as transmitted by the communication node.

The means for performing identifying said signal paths may comprise means for performing: extracting one or more power peaks of the processed sampled received positioning reference signal that are above a threshold level.

Some example embodiments further comprise means for performing receiving angle of departure information from said communication node. Alternatively, or in addition, the means for performing identifying said signal paths may comprises approximating transmission delays to be on a grid having a resolution. The said resolution may be implementation specific and may, for example, be selected by the means (e.g. the model) for performing estimating the orientation of the user device and the gain of each of the signals paths of the multipath signal.

Some example embodiments further comprise refining the model until a termination condition is reached (e.g. using a stagewise orthogonal matching pursuit algorithm). Furthermore, the apparatus may comprise means for performing: determining a difference between a first estimate of the orientation of the user device generated by an iteration of the model and a preceding estimate of the orientation of the user device generated by a preceding iteration of the refinement of the model; and determining that the termination condition (e.g. a predefined number of iterations of refinement of the model or some other termination condition) has been reached in the event that said difference is below a threshold level.

The positioning reference signals may be transmitted as FR2 or mmWave (millimetre wave) signals.

Some example embodiments further comprise means for performing identifying said line-of-sight component.

The means may comprise: at least one processor; and at least one memory including computer program code, the at least one memory and computer program code configured to, with the at least one processor, cause the performance of the apparatus.

In a second aspect, this specification describes a user device comprising an apparatus as described above with reference to the first aspect.

In a third aspect, this specification describes a method comprising: sampling a positioning reference signal received at a user device of a mobile communication system from a communication node of the mobile communication system, wherein the received positioning reference signal is a multipath signal having a line of sight component; processing (e.g. post-processing) the sampled received positioning reference signal with the positioning reference signal as transmitted by the communication node; identifying, based on said processing, signal paths from the communication node to the user device relative to an angle of departure of the positioning reference signal; and generating a model (e.g. mapping the received positioning reference signal to an angle-delay domain) to estimate an orientation of the user device and a gain of at least one of the one or more identified signal paths of the multipath signal. The method may further comprise generating a vector based on the identified signal paths.

The processing may take the form of cross-correlation of the sampled received positioning reference signals with the positioning reference signal as transmitted by the communication node.

The identifying said signal paths may comprise: extracting one or more power peaks of the processed sampled received positioning reference signal that are above a threshold level.

Some example embodiments further comprise receiving angle of departure information from said communication node. Alternatively, or in addition, identifying said signal paths may comprises approximating transmission delays to be on a grid having a resolution.

Some example embodiments further comprise refining the model until a termination condition is reached (e.g. using a stagewise orthogonal matching pursuit algorithm). Furthermore, the method may comprise: determining a difference between a first estimate of the orientation of the user device generated by an iteration of the model and a preceding estimate of the orientation of the user device generated by a preceding iteration of the refinement of the model; and determining that the termination condition (e.g. a predefined number of iterations of refinement of the model or some other termination condition) has been reached in the event that said difference is below a threshold level.

Some example embodiments further comprise identifying said line-of-sight component. In a fourth aspect, this specification describes computer-readable instructions which, when executed by a computing apparatus, cause the computing apparatus to perform (at least) any method as described with reference to the third aspect.

In a fifth aspect, this specification describes a computer-readable medium (such as a non-transitory computer-readable medium) comprising program instructions stored thereon for performing (at least) any method as described with reference to the third aspect.

In a sixth aspect, this specification describes an apparatus comprising: at least one processor; and at least one memory including computer program code which, when executed by the at least one processor, causes the apparatus to perform (at least) any method as described with reference to the third aspect.

In a seventh aspect, this specification describes a computer program comprising instructions for causing an apparatus to perform at least the following: sampling a positioning reference signal received at a user device of a mobile communication system from a communication node of the mobile communication system, wherein the received positioning reference signal is a multipath signal having a line of sight component; processing the sampled received positioning reference signal with the positioning reference signal as transmitted by the communication node; identifying, based on said processing, signal paths from the communication node to the user device relative to an angle of departure of the positioning reference signal; and generating a model (e.g. mapping the received positioning reference signal to an angle-delay domain) to estimate an orientation of the user device and a gain of at least one of the one or more identified signal paths of the multipath signal.

In an eighth aspect, this specification describes an apparatus comprising a first processor (or some other means) for sampling a positioning reference signal received at a user device of a mobile communication system from a communication node of the mobile communication system, wherein the received positioning reference signal is a multipath signal having a line of sight component; a cross-correlation module (or some other means) for processing (e.g. post-processing) the sampled received positioning reference signal with the positioning reference signal as transmitted by the communication node; a second processor (or some other means) for identifying, based on said processing, signal paths from the communication node to the user device relative to an angle of departure of the positioning reference signal; and a model (or some other means) estimating (e.g. by for mapping the received positioning reference signal to an angle-delay domain) an orientation of the user device and a gain of at least one of the one or more identified signal paths of the multipath signal.

### BRIEF DESCRIPTION OF DRAWINGS

Example embodiments will now be described, by way of non-limiting examples, with reference to the following schematic drawings, in which:

FIGS. 1 and 2 are flow charts showing methods or algorithms in accordance with example embodiments;

FIGS. 3 and 4 are block diagram of systems in accordance with example embodiments;

FIG. 5 is a plot showing an example signals received by a user device of the system of FIG. 4.

FIG. 6 to 8 are flow charts showing methods or algorithms in accordance with example embodiments;

FIGS. 9 to 12 are plots showing aspects of performance of example embodiments;

FIG. 13 is a block diagram of components of a system in accordance with an example embodiment; and

FIG. 14 shows an example of tangible media for storing computer-readable code which when run by a computer may perform methods according to example embodiments described above.

### DETAILED DESCRIPTION

The scope of protection sought for various embodiments of the invention is set out by the independent claims. The embodiments and features, if any, described in the specification that do not fall under the scope of the independent claims are to be interpreted as examples useful for understanding various embodiments of the invention.

In the description and drawings, like reference numerals refer to like elements throughout.

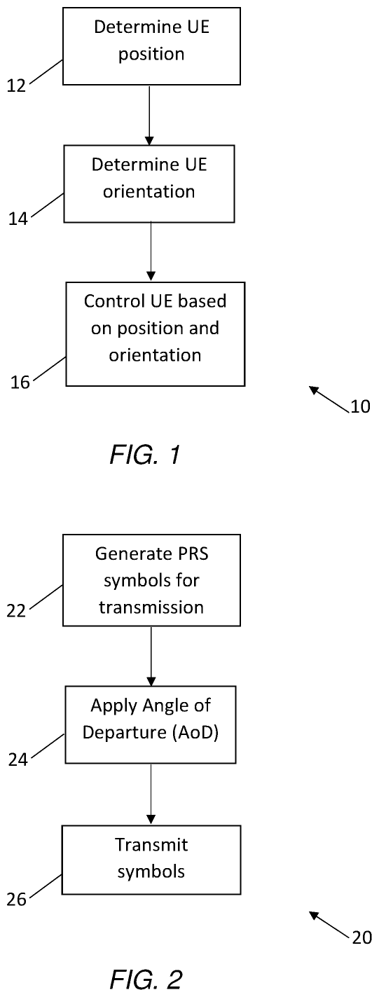

FIG. 1 is a flow chart, indicated generally by the reference numeral 10, showing a method or algorithm in accordance with an example embodiment.

The algorithm 10 starts at operation 12, where a position of a user device of a mobile communication system is determined. By way of example, in user device (or user equipment) assisted positioning (e.g. UE-assisted positioning), a network configures the user device to measure and report some reference signals used for positioning purposes, referred to as positioning reference signals (PRS). This refers to a radio access technology (RAT)-dependent UE-based positioning, since the location of the UE is obtained under network control and configuration.

In some applications, the location of the user device itself (as determined in the operation 12) is not sufficient, particularly when this concerns mutual operations between UEs. Examples of such applications are automated guided vehicles (AGVs) which collaborate with each other for completing a common task (such as loading objects between automated trucks in a factory automation scenario), or AGVs which are configured to take a particular orientation for completing their task (such as automated forklifts). Such scenarios may be applied either in a vehicle-to-everything (V2X) setup, where the location of the UEs is typically obtained via RAT-independent approaches such as global navigation satellite system (GNSS) assisted by the network, or in indoor industrial setups (e.g., factory halls) where the full positioning service is provided by the network.

At operation 14 of the algorithm 10, the orientation of the user device is determined. In the context of 3GPP, user device orientation (or UE-orientation) may be implemented by means of radio-based techniques and network assistance (network-assisted UE orientation).

Finally, at operation 16, the user device is controlled based on the determined position and orientation.

Radio-based, network-assisted UE orientation typically refers to cases where the UE is providing solutions for finding its orientation that are network-dependent. Solutions independent from the network might include scenarios where sensors, compass or inertia measurements are used to determine the UE orientation.

It may be possible to estimate the orientation of the UE using knowledge on the coordinates of transmission points (TRPs) such as base stations. However, network operators are often reluctant to disclose the coordinates of the network transmission points, as this may be considered to be sensitive information.

In the example embodiments described herein, it is generally the network in conjunction with the UE that provides orientation information to the UE.

FIG. 2 is a flow chart showing a method or algorithm, indicated generally by the reference numeral 20, in accordance with an example embodiment. The algorithm 20 may be used to generate positioning reference signals that can be used to determine the orientation (as well as the position) of a user device.

The algorithm 20 starts at operation 22, where a transmitter (such as a communication node of a mobile communication system) generates a positioning reference signal s(t) for transmission.

At operation 24, the positioning reference signal (PRS) s(t) is beamformed by applying a known Angle of Departure (AOD) θ₀ with respect to a common reference direction, e.g., North. The AOD may be based on a direction (or bearing) from the transmitter to a user device. This AOD information θ₀ may be communicated via standard LTE Positioning Protocol (LPP) assistance data (LPP-AD).

At operation 26, the positioning reference signal is transmitted in the direction θ₀.

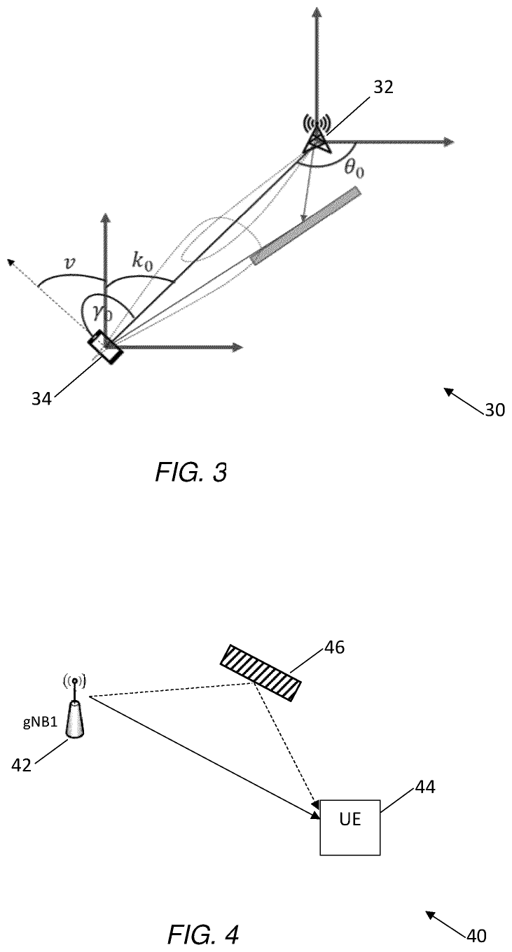

FIG. 3 is a block diagram of an example system, indicated generally by the reference numeral 30, in accordance with an example embodiment. The system 30 may be used to implement the algorithm 20.

The system 30 comprises a communication node 32 (such as a base station, gNB or TRP) and a user device 34.

The communication node 32 applies an angle of departure θ₀ to a PRS symbol for transmission (thereby implementing the operation 24 of the algorithm 20). That PRS symbol is then transmitted from the communication node 32 to the user device 34 (thereby implementing the operation 26 of the algorithm 20).

At the user device 34, the angle of arrival γ₀ is the sum of the UE orientation angle ν and the physical angle of arrival in a common reference system (i.e. w.r.t to a common direction e.g. North) k₀, i.e γ₀=ν+k₀ as shown in FIG. 3.

Given information regarding the angles of departure and arrival in the system 30, the user device orientation ν can be determined, thereby implementing the operation 14 of the algorithm 10. However, real-world systems may be more complicated than the system 30. For example, signals received at the user device 34 from the communication node 32 may be received as multipath signals. Moreover, the user device 34 may simultaneously receive multiple signals from multiple transmitting communication nodes.

FIG. 4 is a block diagram of an example system, indicated generally by the reference numeral 40. The system 40 comprises a communication node 42 (e.g. a gNB), a user device 44 (e.g. UE) and a reflective surface 46.

The communication node 42 is used to transmit positioning reference signals (PRS) to the user device 44 (as indicated by the solid line in the system 40). As discussed elsewhere in this document, if the angle of departure of the PRS is known, then the angle of arrival of that signal at the user device 44 can be used to determine the orientation of the user device. However, a strong reflection of the transmitted PRS via the reflective surface 46 (as indicated by the dotted link in the system 40) may complicate the calculation of that orientation.

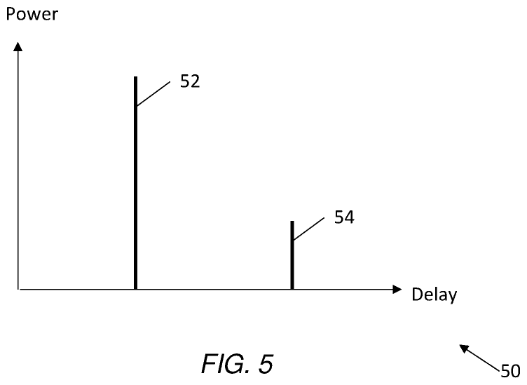

By way of example, FIG. 5 is a plot, indicated generally by the reference numeral 50, showing example positioning reference signals received (or measured) by the user device 44 of the system 40. The plot 50 shows a relatively high power signal 52 received at the user device with a first propagation delay. That signal is a result of the line-of-sight transmission from the communication node 42 to the user device 44. The plot 50 also shows a lower power signal 54 that is received after a longer propagation delay. That lower power signal is a result of the reflected (and thereby delayed) signal received at the user device 44.

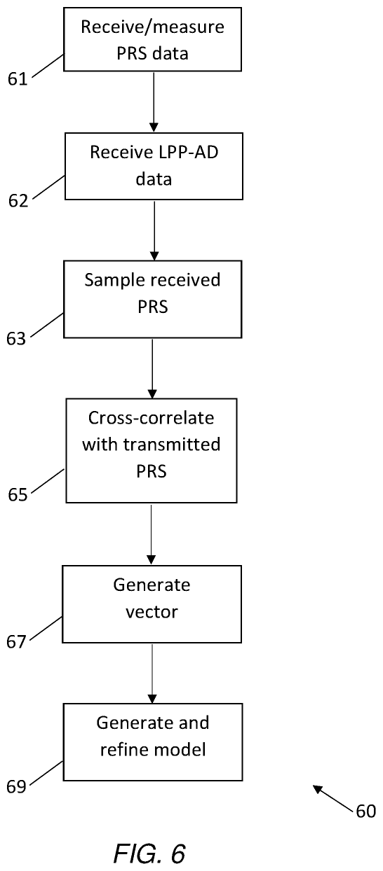

FIG. 6 is a flow chart showing a method or algorithm, indicated generally by the reference numeral 60, in accordance with an example embodiment.

The algorithm 60 starts at operation 61, where a positioning reference signal (PRS) is measured. Then, at operation 62, LTE positioning protocol assistance data (LPP-AD) (including angle of departure information relating to the PRS signal) is received. For example, the PRS and LPP-AD may be obtained at a user device (such as the user device 34 or 44 described above) from a communication node of a mobile communication system (such as the node 32 or 42 described above). The LPP-AD is a message that contains information regarding PRS resources, e.g. providing information to the device regarding what time/frequency resources to measure as PRS.

The measured positioning reference signal is sampled at operation 63 of the algorithm 60. As discussed further below, the received PRS may be a multipath signal having a line of sight component.

At operation 65, the sampled positioning reference signal is cross-correlated with the positioning reference signal as transmitted by the communication node (which transmitted PRS is known). The parameters for the transmitted PRS signal may be sent as part of the LPP-AD data received in the operation 62.

At operation 67, a vector is generated based on said cross-correlation. As discussed in detail below, the vector identifies signal paths from the communication node to the user device relative to an angle of departure of the positioning reference signal.

At operation 69, a model is generated to estimate an orientation of the user device and a gain of at least one (e.g. each) of the one or more identified signal paths of the multipath signal. The model may then be refined, as discussed further below. For example, the model may be refined by updating the estimated terms to minimise a residual signal obtained by subtracted the estimated signal obtained from the model from the observed signals.

The algorithm 60 may be used to estimate an orientation angle of a user device, and additionally to compute an estimate of parameters of the beamed channel, e.g. time of arrivals and phases of the positioning waveform. To do that, the receiver uses information available in the LPP assistance data (AD) received in the operation 61 and the model generated in the operation 69 that exploits the properties of the narrow-beamed channel between the transmitter and the receiver and the relationship between the orientation angle of the UE, the angle of arrival and angle of departure of the PRS waveform traveling the direct path between the transmitter and the user device.

The algorithm 60 may be implemented using 5G NR (New Radio) FR2 signals (and beyond), referring to propagation conditions above 24 GHz. These channels typically consist of very few multipath components with a single visible dominant path, given the challenging radio channel characterized by severe attenuation and absorption losses.

To ensure signal reception in such harsh environment, transmit and receive narrow beams are typically used to focus signal energy over a narrowly beamed FR2 channel, i.e. a spatially narrow channel, with a strong line-of-sight (LOS) component and potentially one or a couple of highly attenuated paths forming the channel tail. In other words, beamforming is user in FR2 to achieve sufficient coverage, and beamforming in this respect is targeted to reach LOS connection with the UEs by concentrating the transmitted energy to the direction of the UE.

In addition, for positioning purposes, transmit-receive beam selection may seek to maximise the LOS likelihood for a UE-TRP link (as the LOS link reflects the true distance), and therefore implementation of the algorithm 60 using FR2 frequencies may assume that all beamed channels for positioning have been established based on LOS presence criterion. The determination of whether the LOS criterion is met may follow standard approaches that estimate whether the measured link is LOS or not. If no LOS channel can be realized for a specific narrow-beam pair, the pair may be deactivated on the basis any subsequent positioning measurements (e.g. TOA, AOA) would be unable to capture information regarding the direct distance between the UE and the TRP, resulting in a poor UE localization accuracy. Therefore, LOS presence is important for both accurate localization and UE orientation estimation in FR2 and beyond. Note that for FR1 operation, an additional and initial step (not shown in FIG. 6) may be included to ensure LOS detection based on prior art solutions. An existing LOS detector, such as a detector using maximum likelihood based LOS estimation or a supervised learning method may be used.

An example implementation of the algorithm 60, performed at the UE, is described below in further detail.

A transmitter (such as the communication node 32 or 42 described above) generates a vector of K complex symbols which are OFDM modulated and prepended an N_{cp} samples CP. The positioning reference signal after OFDM modulation s(t) is beamformed by applying a known Angle of Departure (AOD) θ₀ with respect to a common reference direction, e.g., North. This AOD θ₀ information is communicated to the UE, for example via LTE Positioning Protocol (LPP) assistance data (LPP-AD) in an implementation of the operation 61 of the algorithm 60.

The resulting signal may be sent by the communication node over a FR2 beamed wireless propagation channel with impulse response consisting of L multipath components:

$$h ( t ) = {α}_{0} exp ( - j π sin {θ}_{0} ) exp ( j π sin {γ}_{0} ) δ ( t - {τ}_{0} ) + b ( t ) , \qquad ( 1 )$$

where:
The path indexed o is the line-of-sight (LOS) path
The channel tail b(t)=Σₗ₌₁^{L-1} bₗ exp(−jπ sin θₗ) exp(jπ sin γₗ) δ(t−τ₁) consists of one or more attenuated reflections.
(θₗ, γₗ, τₗ, bₗ) are the angle of departure, angle of arrival, delay and complex gain of the 1-th path respectively.

Thus, in this example, the LOS path is dominant when compared with the channel tail due to non-LOS transmissions.

Without loss of generality, assume that α₀ is the gain of the LOS component which arrives at a receiver with a delay τ₀. We call this delay TOA of LOS (time of arrival of the line-of-sight component). Note that a positioning beam selection may previously have been realized in order to capture a LOS channel.

The received signal at the positioning receiver (such as the user device 34 or 44 described above) is subsequently:

$$y ( t ) = ( s * h ) ( t ) + ξ ( t ) ,$$

where (*) denotes convolution and ζ is additive white Gaussian noise (AWGN).

Thus the received signal (γ(t)) is dependent on the channel response h(t), the transmit signal s(t) and a white noise component.

As described in detail above, the angle of arrival (AoA) is dependent on the UE orientation angle and the Angle of Departure (AoD) of the communication. More specifically, the relationship between physical AOA and AOD for a LOS path is

$${γ}_{0} \approx {θ}_{0} + v - \frac{π}{2} .$$

Thus, sin γ₀=−cos(θ₀+ν).

After reception, the received signal γ(t) is sampled and cross-correlated, by the UE, with the known transmit signal (thereby implementing the operations 63 and 65 of the algorithm 60) to yield a vector of N samples, where NTₛ is the total observation window over which the signal is collected:

$$r = {[ {r}_{0} , … . , {r}_{N} ]}^{T} , where {r}_{d} = r ( d {T}_{S} ) , i . e . {r}_{d} = {α}_{0} exp ( - j π sin {θ}_{0} ) exp ( j π sin {γ}_{0} ) Γ ( d - {d}_{0} ) + {Σ}_{l = 1}^{L - 1} {b}_{l} exp ( - j π sin {θ}_{l} ) exp ( j π sin {γ}_{l} ) Γ ( d - {d}_{l} ) + {w}_{d} ,$$

where

$${d}_{l} = \frac{{τ}_{l}}{{T}_{s}} . Γ ( d - {d}_{0} )$$

is the known auto-correlation function of the transmit sequence and Tₛ is the sampling time of the system.

Then, the d-th sample reads:

$${r}_{d} = {α}_{0} exp ( - j π ( sin {θ}_{0} + cos ( {θ}_{0} + v ) ) ) Γ ( d - {d}_{0} ) + {Σ}_{l = 1}^{L - 1} {b}_{l} exp ( - j {θ}_{l} ) exp ( j {γ}_{l} ) Γ ( d - {d}_{l} ) + {w}_{d} .$$

The vector r can be re-written by further approximating the delays to be on a grid with selected resolution, Tₛ/o, i.e.

$${d}_{l} = \frac{l}{o} ,$$

L=N_{cp}−1, and o is a positive integer factor, selected by implementation:

$$r = Γ g + w \qquad ( 2 )$$

Where Γ_{d,l}=Γ(d−l), and the approximated channel vector is

$$g = {[ {α}_{0} f ( v ) , {α}_{1} , … , {α}_{L - 1} ]}^{T}$$

where

$$f ( v ) = exp ( - j π ( sin {θ}_{0} + cos ( {θ}_{0} + v ) ) ) and {α}_{l} = {b}_{l} exp ( - j {θ}_{l} ) exp ( j {γ}_{l} ) .$$

Thus, the step of generating the vector in operation 67 of the algorithm 60 may comprise approximating propagation delays to be on a grid having a resolution. The resolution may be implementation specific and may, for example, be selected based on the relevant model.

The goal becomes then to jointly estimate the orientation angle ν and the gains of all multipath components α=[α₀, . . . , α_{L-1}]^{T}. To that end, we can formulate the optimization problem:

$$\hat{v} , \hat{α} = arg min {‖ r - Γ ( e ⊙ α ) ‖}_{2}^{2} \qquad ( 3 )$$

Where e=[exp(jπƒ(ν)), 1, . . . , 1]^{T}∈C^{L}, and ⊙ denotes the Hadamard product.

To simplify the problem (3), we can assume that the channel is composed of a known number of relevant components, i.e. the size of a is known, e.g. obtained from extracting the main peaks (e.g. local maxima) of the power vector p=[|r₀|², . . . , |r_{N}|²], where r_{d} is defined above. Those peaks can be used to initialise the algorithm, as discussed further below.

Thus, the step of generating the vector in operation 67 of the algorithm 60 may comprise extracting, by the UE, one or more peaks (e.g. local maxima) of the cross-correlation that are above a threshold level. The threshold level may be fixed, but this is not essential in all example embodiments. For example, the number of peaks may be fixed, or the number of peaks may be increased until a set percentage of the received energy is account for. The skilled person will be aware of other variants that could be implemented.

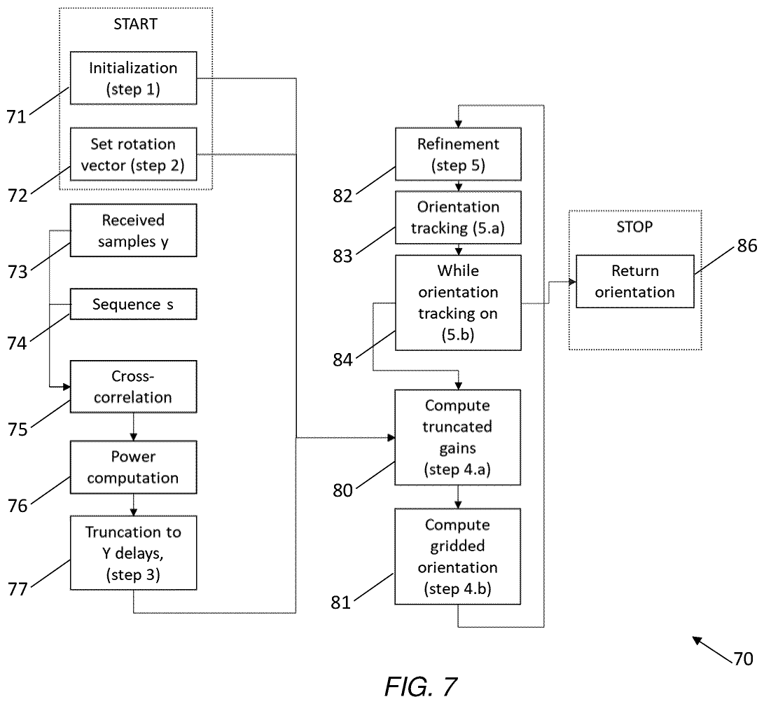

FIG. 7 is a flow chart showing a method or algorithm, performed by the UE, indicated generally by the reference numeral 70, in accordance with an example embodiment. The algorithm 70 may be used to solve the problem (3) outlined above.

At operation 71, an initialisation step starts with computing the vector of the transmitted PRS signal (denoted by Γ) and initialising the variables Y, \hat{ν}, and α_{Y}(e.g. Y=10, initialize \hat{ν}=0, \hat{α}_{Y}=1).

At operation 72, the rotation vector estimate e is initialised (e.g. e=[exp(jπƒ(\hat{ν})), 1, . . . , 1]^{T}).

Separately, at operation 73, the transmitted PRS signal is received at the user device as the signal γ(t). As discussed above, the received signal is denoted by:

$$y ( t ) = ( s * h ) ( t ) + ξ ( t ) ,$$

where (*) denotes convolution and ζ is AWGN.

At operation 74 (and as discussed above), the received signal γ(t) is sampled (so that discrete signal samples γₖ=γ(kTs) are obtained). Then, at operation 75, the sampled received PRS signal is cross-correlated with the known transmit PRS signal (thereby implementing the operation 65 of the algorithm 60) to yield a vector of N samples.

At operation 76, the instantaneous power of the cross-related received signal is generated and, at operation 77, Y non-zero locations in a are selected, for example by retaining the indices of the Y peaks of p=[|r₀|², . . . |r_{N}|²]. We call the resulting vector α_{Y}., which is the estimate of non-LOS components of the channel (e.g. reflections).

Next, the initialised data is used in a first (coarse) estimation process.

At operation 80, channel weights are computed by minimizing the residual signal obtained by subtracting the contribution of the estimated weights from the received signal.

For example, solve \hat{α}_{Y}=arg min∥r−Γ(ê⊙α)∥₂² using e.g. stagewise orthogonal matching pursuit (STOMP) method:

STOMP routine
Define projection matrix and update residual signal
E = Γ diag(ê)
filtered_residual = E′*residual;
Compute AWGN contribution to the rx. signal
lambda = N/(sum(abs(r−E*(\hat{α_{Y}})).\hat{ }2));
index_taps = find(abs(filtered_residual).\hat{ }2>constant/lambda);
Choose delays that minimize the residual
all_indices = unique(sort([all_indices; index_taps]));
E = E(:, all_indices);
Compute channel weights by e.g. zero-forcing
\hat{α_{Y}}(all_indices) = (pinv(E′*E)*(E′*r));
residual = r − E*\hat{α_{Y}};
note that E′ stands for Hermitian operation.

After computing the channel weights, the orientation angle can be obtained, by minimizing the residual signal obtained by subtracting the contribution of the estimated weights affected by a variable orientation from the received signal. For example, at operation 81, an angular gridded search like below may be used.

```
Define angle grid with chosen resolution X
    rng_o = o:X:2*pi;
Test each point in the grid if it minimizes residual signal
  for angle = rng_o
      phase (1) = exp(1j*pi*cos(angle));
      res = [res sum(abs(r−E*(\hat{α_{Y}}.*phase)).\hat{ }2)];
  end
        \hat{v}= rng_o(find(res == min(res)));
  ê(1) = exp(1j*pi*cos(f(\hat{v})));
```

At the end of the first instance of the operation 81, a coarse estimate has been generated. The algorithm them moves to operation 82, where a refinement process begins.

The orientation process starting at operation 82 has a first part (operation 83) where orientation tracking (i.e. how the orientation changes from one iteration to another) seeks to determine whether the estimated tracking matches the real data. At operation 84, a determination is made regarding whether the tracking is sufficiently accurate. For example, the refinement process may consist of iterative updates of the orientation angle, channel gains and noise variance until the orientation angle has converged (e.g. the variance between two updates is smaller than a convergence threshold).

If the tracking is accurate, no further refinement is required and the algorithm terminates at operation 86 with the orientation data (and other data) being returned. Otherwise, the algorithm moves to a further instance of operations 80 and 81, where the data model is refined. The operation 86 may include the orientation data being transmitted to the network or to some external server; in other example embodiments, the orientation data is retained at the user device.

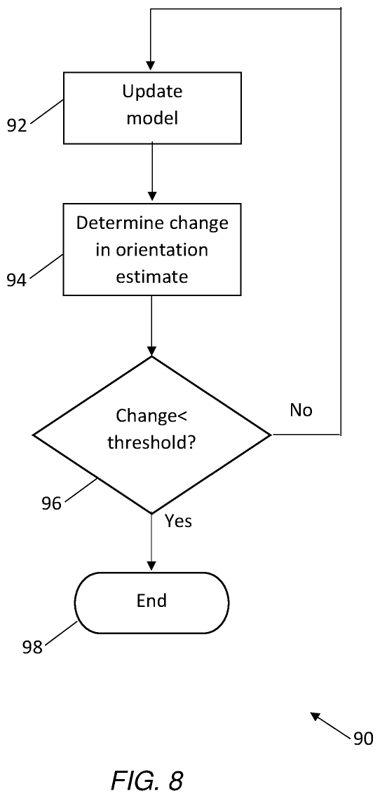

FIG. 8 is a flow chart showing a method or algorithm, indicated generally by the reference numeral 90, in accordance with an example embodiment. The algorithm 90 provides an example algorithm for determining whether the algorithm 70 is complete (e.g. whether convergence has occurred or whether the algorithm can be stopped for some other reason).

The algorithm 90 starts at operation 92, where the model is updated. The operation 92 may be implemented using the operations 80 and 81 of the algorithm 70 described above.

At operation 94, a determination is made (e.g. by a user device configured to determine the difference) regarding the difference between a new orientation estimate ν and the orientation estimate \hat{ν}_{old} of a previous iteration of the algorithm 90.

At operation 94, a determination is made (e.g. by a user device configured to determine the difference) regarding the difference between a first (new) estimate of the orientation of the user device (denoted by \hat{ν}) generated by the present iteration of the model and a preceding estimate of the orientation of the user device (denoted by \hat{ν}_{old}) generated by a preceding iteration of the refinement of the model.

At operation 96, it is determined that a termination condition has been reached in the event that said difference is below a threshold level (e.g. \hat{ν}-\hat{ν}_{old}|>k). For example, the user device may be configured to determine that the termination condition has been reached.

If the termination condition has been reached, then the algorithm 90 terminates at operation 98; otherwise, the algorithm 90 returns to operation 92 so that the model is further refined.

Alternatives to the algorithm 90 are possible. For example, in one embodiment, the termination condition comprises a predefined number of iterations of refinement of the model. Thus, the model is refined a defined number of times and then assumed to be sufficiently accurate. A combination of the algorithm 90 and the use of a predetermined number of iterations is possible (e.g. a minimum or a maximum number of iterations may be defined).

As discussed in detail above, a method has been devised for generating an estimation model that seeks to capture the relationship between UE orientation and the channel geometry of the narrow-beamed FR2 channel. One example estimation model computes approximations of:
The UE orientation in a common reference system; and
The parameters of the wireless channel such as time of arrival and phase.

For example, the method may leverage the geometrical relationship between the orientation angle of the user device, and the angles of departure (AOS) and arrival (AOA) of a positioning reference signal waveform propagating over a direct (line-of-sight) path.

A tap detection approach has been devised that seeks to constrain the search space for the channel taps estimation and obtain a first channel and orientation estimates. Following this, the resulting channel can be truncated by retaining relevant channel taps (or alternatively, relevant delay ranges, i.e. where the channel power is concentrated in). Then, an initial pair (orientation, channel impulse) can be used to refine the pair estimates around the coarse values.

In addition, the concepts described herein can be extended to include the effect of reported beam offset errors to provide robustness against RF imperfections and to estimate noise levels of each received signal.

A number of variants of the algorithms described herein may be possible, some of which are outlined below.
The truncation to the Y taps may be removed from the operation 77 of the algorithm 70. For example, all taps may be considered as relevant and the solution generated in the operation 80 may be replaced by e.g. STOMP, LASSO solutions etc.
The refinement condition may be replaced with a noise level convergence condition (e.g., when the noise precision becomes stable over iterations), or with reaching a maximum number of iterations.
The initialization step (see operation 71 described above) may be implemented using past estimates of Y and respectively of the orientation, if, for example, the UE is considered semi-static and/or has a large form factor.
The condition (3) described above may be expanded to include beam offsets errors e, e.g. recast as

$${γ}_{0} = {θ}_{0} + v - \frac{π}{2} + ϵ .$$

The error margin e can be indicated by the LMF to the UE via assistance data and included in the function ƒ(ν) which can be recast as:

$$f ( v ) = exp ( - j π ( sin ( {θ}_{0} + ε ) + cos ( {θ}_{0} + v + ϵ ) ) ) .$$

The method can be transformed to frequency-domain, by collecting the samples after OFDM demodulation for the synchronized case. Then, the method can be applied by replacing the ACF matrix with an oversampled DFT matrix. Specifically, Γ in (2) becomes

$$F , F ( a , b ) = exp ( - \frac{2 π jab}{o N} ) ,$$

where o acts as an artificial-sampling factor.
The method can be extended for FR1 operation, by including a first step of LOS detection. Upon the LOS probability and/or LOS path reconstruction being finalized, the method described herein can be applied. Specifically, the delay raster defined before eq. (2) is aligned with the LOS delay τ₀, i.e. d0=τ0/(Ts/0).
The method can be applied in uplink positioning, where the TRP computes the UE orientation using UL SRS reception and UE UL AOD information, the latter being provided by the UE in a common coordinate system via explicit signaling.

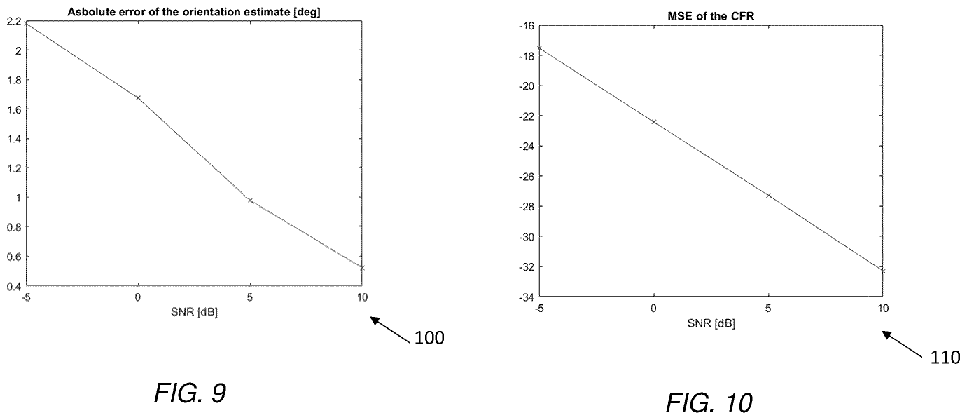

FIGS. 9 to 12 are plots, indicated generally by the reference numerals 100, 110, 120 and 130 respectively, showing aspects of performance of example embodiments.

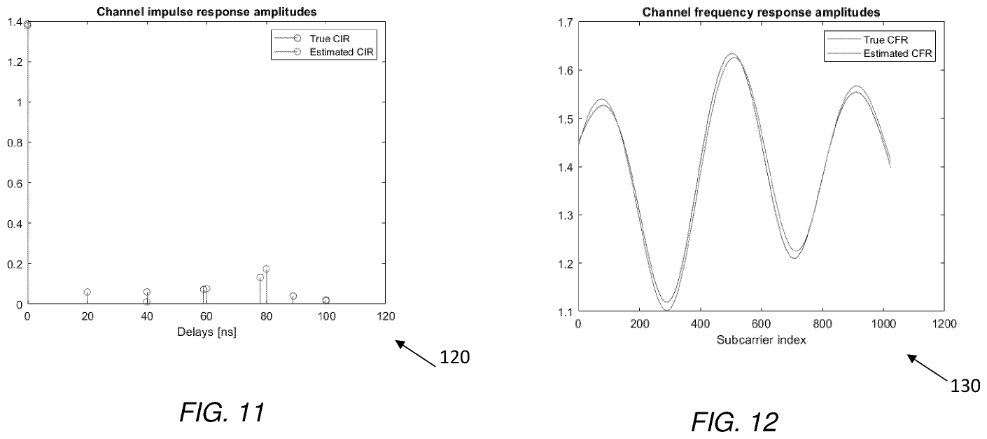

To evaluate the performance of the proposed methods described herein, a PRS signal was generated with 15 MHz bandwidth received over a line of sight beamed channel composed of six multipaths (see the channel impulses shown in FIG. 11). The SNR level was varied in [−5, 10] dB range and set an orientation angle equal to 57 degrees (=1 radian). The resulting performance is plotted in FIGS. 9 to 12. Specifically, we observe:
Accurate UE orientation estimation in all tested SNR regimes, e.g. 0.5 degrees UE orientation estimation error at 10 dB, and 2 degrees at −5 dB (see FIG. 9).
Accurate channel reconstruction, with very low mean square error (MSE) of the channel frequency response (CFR) even for low SNR regimes, i.e. −18 dB error at SNR=−5 dB (see FIG. 10 and FIG. 12)
Accurate channel parameters reconstruction, with more than 90% accuracy on detecting the relevant taps (FIG. 11).

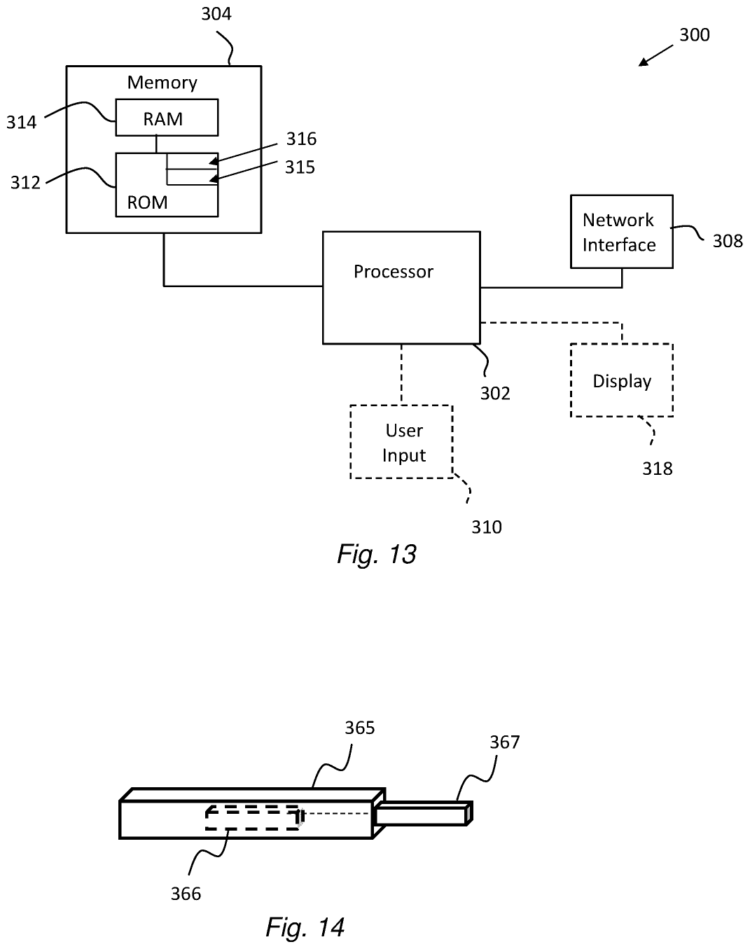

For completeness, FIG. 13 is a schematic diagram of components of one or more of the example embodiments described previously, which hereafter are referred to generically as a processing system 300. The processing system 300 may, for example, be (or may include) the apparatus referred to in the claims below.

The processing system 300 may have a processor 302, a memory 304 coupled to the processor and comprised of a random access memory (RAM) 314 and a read only memory (ROM) 312, and, optionally, a user input 310 and a display 318. The processing system 300 may comprise one or more network/apparatus interfaces 308 for connection to a network/apparatus, e.g. a modem which may be wired or wireless.

The network/apparatus interface 308 may also operate as a connection to other apparatus such as device/apparatus which is not network side apparatus. Thus, direct connection between devices/apparatus without network participation is possible.

The processor 302 is connected to each of the other components in order to control operation thereof.

The memory 304 may comprise a non-volatile memory, such as a hard disk drive (HDD) or a solid state drive (SSD). The ROM 312 of the memory 304 stores, amongst other things, an operating system 315 and may store software applications 316. The RAM 314 of the memory 304 is used by the processor 302 for the temporary storage of data. The operating system 315 may contain code which, when executed by the processor implements aspects of the methods and algorithms 10, 20, 60, 70 and 80 described above. Note that in the case of small device/apparatus the memory can be most suitable for small size usage i.e. not always a hard disk drive (HDD) or a solid state drive (SSD) is used.

The processor 302 may take any suitable form. For instance, it may be a microcontroller, a plurality of microcontrollers, a processor, or a plurality of processors.

The processing system 300 may be a standalone computer, a server, a console, or a network thereof. The processing system 300 and needed structural parts may be, for example, inside device/apparatus such as IoT device/apparatus.

In some example embodiments, the processing system 300 may also be associated with external software applications. These may be applications stored on a remote server device/apparatus and may run partly or exclusively on the remote server device/apparatus. These applications may be termed cloud-hosted applications. The processing system 300 may be in communication with the remote server device/apparatus in order to utilize the software application stored there.

FIG. 14 shows tangible media, specifically a removable memory unit 365, storing computer-readable code which when run by a computer may perform methods according to example embodiments described above. The removable memory unit 365 may be a memory stick, e.g. a USB memory stick, having internal memory 366 for storing the computer-readable code. The internal memory 366 may be accessed by a computer system via a connector 367. Other forms of tangible storage media may be used. Tangible media can be any device/apparatus capable of storing data/information which data/information can be exchanged between devices/apparatus/network.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices/apparatus and other devices/apparatus. References to computer program, instructions, code etc. should be understood to express software for a programmable processor firmware such as the programmable content of a hardware device/apparatus as instructions for a processor or configured or configuration settings for a fixed function device/apparatus, gate array, programmable logic device/apparatus, etc.

If desired, the different functions discussed herein may be performed in a different order and/or concurrently with each other. Furthermore, if desired, one or more of the above-described functions may be optional or may be combined. Similarly, it will also be appreciated that the flow diagrams of FIGS. 1, 2, 6, 7 and 8 are examples only and that various operations depicted therein may be omitted, reordered and/or combined.

It will be appreciated that the above described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

Although various aspects of the invention are set out in the independent claims, other aspects of the invention comprise other combinations of features from the described example embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1. An apparatus comprising:
at least one processor; and
at least one memory storing instructions that, when executed by the at least one processor, cause the apparatus at least to:
sample at least a positioning reference signal received at the apparatus of a mobile communication system from a communication node of the mobile communication system, wherein the received positioning reference signal is a multipath signal having a line of sight component;
process the sampled received positioning reference signal with a transmitted positioning reference signal as transmitted by the communication node;
identify, based on the processing, one or more signal paths from the communication node to the apparatus relative to an angle of departure of the transmitted positioning reference signal; and
generate a model to estimate an orientation of the apparatus and a gain of at least one of the one or more identified signal paths of the multipath signal.

2. The apparatus of claim 1, wherein the apparatus caused to process comprises the apparatus caused to perform cross-correlation of the sampled received positioning reference signal with the transmitted positioning reference signal as transmitted by the communication node.

3. The apparatus of claim 1, wherein the apparatus caused to identify comprises the apparatus caused to extract one or more power peaks of the processed sampled received positioning reference signal that are above a threshold level.

4. The apparatus of claim 1, wherein the apparatus is further caused to receive angle of departure information for the transmitted positioning reference signal from the communication node.

5. The apparatus of claim 1, wherein the apparatus caused to identify comprises the apparatus caused to approximate transmission delays to be on a grid having a resolution.

6. The apparatus of claim 1, wherein the apparatus is further caused to refine the model until a termination condition is reached.

7. The apparatus of claim 6, wherein the apparatus caused to refine the model comprises the apparatus caused to refine the model using a stagewise orthogonal matching pursuit algorithm.

8. The apparatus of claim 6, wherein the apparatus is further caused to:
determine a difference between a first estimate of the orientation of the user device generated by an iteration of the model and a preceding estimate of the orientation of the user device generated by a preceding iteration of the refinement of the model; and
determine that the termination condition has been reached in an event that the difference is below a threshold level.

9. The apparatus of claim 6, wherein the termination condition comprises a predefined number of iterations of refinement of the model.

10. The apparatus of claim 1, wherein the transmitted positioning reference signal is transmitted as a FR2 or mmWave signal.

11. The apparatus of claim 1, wherein the apparatus is further caused to identify the line of sight component.

12-13. (canceled)

14. A method comprising:
sampling at least a positioning reference signal received at a user device of a mobile communication system from a communication node of the mobile communication system, wherein the received positioning reference signal is a multipath signal having a line of sight component;
processing the sampled received positioning reference signal with a transmitted positioning reference signal as transmitted by the communication node;
identifying, based on the processing, one or more signal paths from the communication node to the user device relative to an angle of departure of the transmitted positioning reference signal; and
generating a model to estimate an orientation of the user device and a gain of at least one of the one or more identified signal paths of the multipath signal.

15. A non-transitory computer-readable storage medium comprising instructions stored thereon that, when executed by at least one processor, are configured to cause a computing system to perform at least the following:
sampling at least a positioning reference signal received at a user device of a mobile communication system from a communication node of the mobile communication system, wherein the received positioning reference signal is a multipath signal having a line of sight component;
processing the sampled received positioning reference signal with the positioning reference signal as transmitted by the communication node;
identifying, based on the processing, one or more signal paths from the communication node to the user device relative to an angle of departure of the positioning reference signal; and
generating a model to estimate an orientation of the user device and a gain of at least one of the one or more identified signal paths of the multipath signal.

16. The method of claim 14, wherein the processing comprises performing cross-correlation of the sampled received positioning reference signal with the transmitted positioning reference signal as transmitted by the communication node.

17. The method of claim 14, wherein the identifying comprises extracting one or more power peaks of the processed sampled received positioning reference signal that are above a threshold level.

18. The method of claim 14, further comprising receiving angle of departure information for the transmitted positioning reference signal from the communication node.

19. The method of claim 14, wherein the identifying comprises approximating transmission delays to be on a grid having a resolution.

20. The method of claim 14, further comprising refining the model until a termination condition is reached.

21. The method of claim 20, further comprising:
determining a difference between a first estimate of the orientation of the user device generated by an iteration of the model and a preceding estimate of the orientation of the user device generated by a preceding iteration of the refinement of the model; and
determining that the termination condition has been reached in an event that the difference is below a threshold level.

22. The method of claim 14, wherein the transmitted positioning reference signal is transmitted as a FR2 or mmWave signal.
